(19) United States
(12) Patent Application Publication
(10) Pub. No.: US 2023/0354484 A1
(43) Pub. Date: Nov. 2, 2023

(54) COOKING APPLIANCE

(71) Applicant: LG ELECTRONICS INC., Seoul (KR)

(72) Inventors: Younghwan KWACK, Seoul (KR); Seongho SON, Seoul (KR)

(73) Assignee: LG ELECTRONICS INC., Seoul (KR)

(21) Appl. No.: 18/142,346

(22) Filed: May 2, 2023

(30) Foreign Application Priority Data
May 2, 2022 (KR) 10-2022-0054375

(51) Int. Cl. H05B 6/06; H05B 6/12

(52) U.S. Cl. CPC H05B 6/065; H05B 6/1272

(57) ABSTRACT

A cooking appliance includes an upper plate configured to support an object to be heated, a first intermediate heating body located at the upper plate, a plurality of working coils configured to generate magnetic fields coupled to at least one of the object to be heated and the first intermediate heating body, an inverter configured to apply current to the plurality of working coils, and a controller configured to control the inverter so that at least one of the plurality of working coils does not operate in a portion of a cycle in a first heating mode.

### CROSS-REFERENCE TO RELATED APPLICATION

This non-provisional application claims the benefit under 35 U.S.C. § 119(a) to Patent Application No. 10-2022-0054375, filed in the Republic of Korea on May 2, 2022, all of which is hereby expressly incorporated by reference into the present application.

### FIELD

The present disclosure relates to a cooking appliance. More particularly, the present disclosure relates to the cooking appliance, which is capable of heating all of a magnetic body and a non-magnetic body.

### BACKGROUND

Various types of cooking appliances are used to heat food at home or in the restaurant. According to the related art, a gas stove using gas as a fuel has been widely used. However, recently, devices for heating an object to be heated, for example, a cooking vessel such as a pot, have been spread using electricity instead of the gas.

A method for heating the object to be heated using electricity is largely divided into a resistance heating method and an induction heating method. The electrical resistance method is a method for heating an object to be heated by transferring heat generated when electric current flows through a metal resistance wire or a non-metal heating body such as silicon carbide to the object to be heated (e.g., a cooking vessel) through radiation or conduction. In the induction heating method, when high-frequency power having a predetermined intensity is applied to a coil, eddy current is generated in the object to be heated using magnetic fields generated around the coil so that the object to be heated is heated.

Recently, most of the induction heating methods are applied to cooktops.

Meanwhile, such a cooking appliance has a limitation in that the heating efficiency of the non-magnetic container is very low compared to the heating efficiency of the magnetic container. Therefore, in order to solve the problem of very low heating efficiency for non-magnetic materials (for example, heat-resistant glass, pottery, or the like), the cooktop includes an intermediate heating body to which eddy current is applied, and the non-magnetic material can be heated through the intermediate heating body.

However, when the cooking appliance is provided with an intermediate heating body, when heating the magnetic container, there is a problem in that some magnetic fields combine with the intermediate heating body to indirectly heat the intermediate heating body before reaching the magnetic container.

### SUMMARY

An object of the present disclosure is to provide a cooking appliance capable of heating all of magnetic, non-magnetic, and non-metallic containers regardless of the container material.

An object of the present disclosure is to minimize a problem of deterioration in heating efficiency of a magnetic container in a cooking appliance including an intermediate heating body.

An object of the present disclosure is to provide a cooking appliance that adjusts the heating value of an intermediate heating body according to the type of an object to be heated.

The present disclosure is intended to improve the convenience of use of a cooking appliance including an intermediate heating body.

The present disclosure can adjust the heating value generated in the intermediate heating body by controlling the operation of a plurality of working coils.

According to the present disclosure, when heating a magnetic container, a plurality of working coils is controlled not to operate simultaneously for at least a portion of the time, thereby reducing the heating value generated in the intermediate heating body and increasing the heating value generated in the container itself.

A cooking appliance according to an embodiment of the present disclosure may include an upper plate, on which an object to be heated is disposed; an intermediate heating body installed on the upper plate; a plurality of working coils configured to generate magnetic fields coupled to at least one of the object to be heated and the intermediate heating body; an inverter configured to apply current to the plurality of working coils; and a controller configured to control the inverter so that at least one of the plurality of working coils does not operate in a portion of a cycle in a first heating mode.

The plurality of working coils may include first and second working coils, and the controller may be configured to control the inverter so that the first working coil operates for a half of the one cycle and the second working coil operates for the other half of the cycle.

The cycle may include a first section in which only the first working coil operates, a second section in which the first and second working coils operate together, and a third section in which only the second working coil operates.

The controller may be configured to control the inverter so that the first working coil operates during the first section of the cycle, the first working coil and the second working coil operate together during the second section after the first section, and the second working coil operate during the third section after the second section.

A time interval corresponding to each of the first to third sections may be the same.

The controller may be configured to adjust the operating frequency of the inverter so that the plurality of working coils generates maximum output in the first heating mode.

The controller may be configured to control the plurality of working coils to operate in the first heating mode when the object to be heated is a magnetic material.

The controller may be configured to control the inverter so that all working coils operate during the one cycle in the second heating mode.

The controller may be configured to control the plurality of working coils to operate in the second heating mode when the object to be heated is a non-magnetic material.

The intermediate heating body may be disposed to overlap with at least two or more working coils among the plurality of working coils in a vertical direction.

The intermediate heating body may be disposed to overlap with some of the plurality of working coils in the vertical direction.

When a plurality of heating zones is previously designated in the upper plate, the intermediate heating body may be installed at a position corresponding to one of the plurality of heating zones.

When the heating zone is not previously designated in the upper plate, the intermediate heating body may be installed at a position corresponding to the center of the plurality of working coils.

When the heating zone is not previously designated on the upper plate, a portion of the intermediate heating body may be installed at a position overlapping with the working coil disposed closest to the vertex of the upper plate in the vertical direction.

### Technical Effects

According to an embodiment of the present disclosure, by controlling the heating value of the intermediate heating body according to the type of object to be heated, there is an advantage in that heating efficiency for each container material can be improved and output performance can be increased.

According to an embodiment of the present disclosure, there is an advantage in that control logic can be simplified in that output performance is improved by selectively operating a plurality of working coils during one cycle without the need to control the phases of the plurality of working coils.

According to an embodiment of the present disclosure, there is an advantage in that the degree of freedom of the container is improved because the heating zone is not designated, and at the same time, when heating the object to be heated placed at the installation position of the intermediate heating body, it is possible to heat with high efficiency regardless of the container material.

### BRIEF DESCRIPTION OF THE DRAWINGS

FIG. 1 is a perspective view illustrating a cooking appliance according to an embodiment of the present disclosure.

FIG. 2 is a circuit diagram of a cooking appliance according to an embodiment of the present disclosure.

FIG. 3 is a cross-sectional view illustrating a cooking appliance and an object to be heated according to an embodiment of the present disclosure.

FIG. 4 is a cross-sectional view illustrating a cooking appliance and an object to be heated according to another embodiment of the present disclosure.

FIG. 5 is a view illustrating an intermediate heating body and a plurality of working coils according to a first embodiment of the present disclosure.

FIG. 6 is a view illustrating an intermediate heating body and a plurality of working coils according to a second embodiment of the present disclosure.

FIG. 7 is a diagram illustrating an intermediate heating body and a plurality of working coils according to a third embodiment of the present disclosure.

FIG. 8 is a diagram illustrating an intermediate heating body and a plurality of working coils according to a fourth embodiment of the present disclosure.

FIG. 9 is a view illustrating output when working coils of a cooking appliance operate simultaneously according to an embodiment of the present disclosure.

FIG. 10 is a view illustrating output when working coils of a cooking appliance alternately operate in a first method according to an embodiment of the present disclosure.

FIG. 11 is a view illustrating an output when a working coil of a cooking appliance alternately operates in a second method according to an embodiment of the present disclosure.

FIG. 12 is a control block diagram illustrating an operating method of a cooking appliance according to an embodiment of the present disclosure.

### DETAILED DESCRIPTION

Hereinafter, preferred embodiments according to the present disclosure will be described in detail with reference to the accompanying drawings. In the drawings, the same reference numerals are used to indicate the same or similar components.

The suffixes “module” and “portion” for components used in the following description are given or used together in consideration of ease of writing the specification, and do not have meanings or roles that are distinct from each other by themselves.

In the following description, “connection” between components includes not only direct connection of components, but also indirect connection through at least one other component, unless otherwise specified.

Hereinafter, a cooking appliance and an operating method thereof according to an embodiment of the present disclosure will be described. Hereinafter, the cooking appliance may be an induction heating type cooktop.

Hereinafter, a cooking appliance according to an embodiment of the present disclosure will be described.

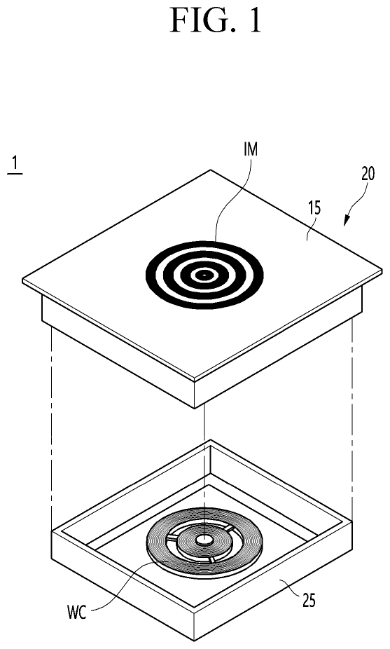

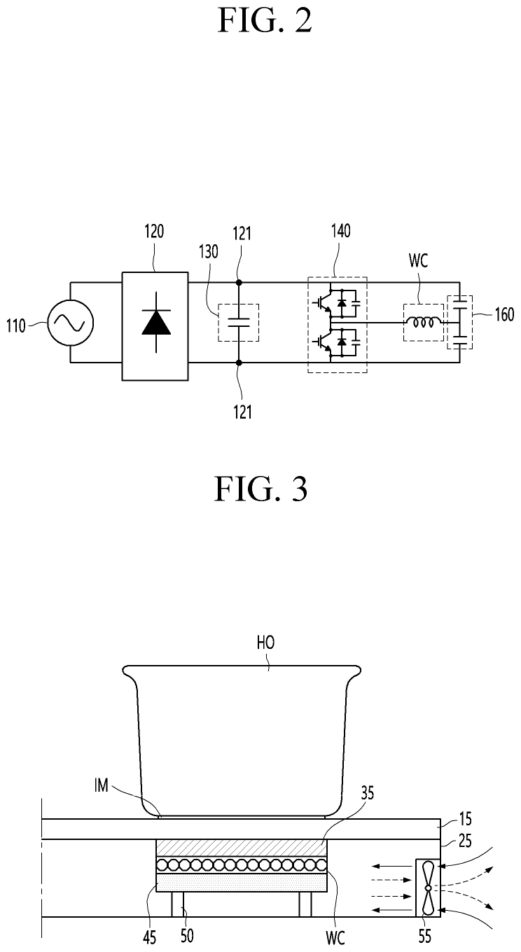

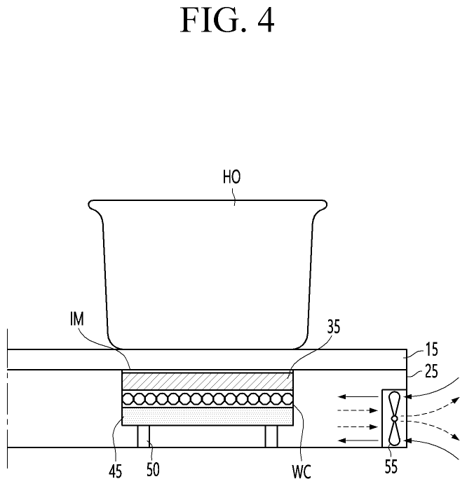

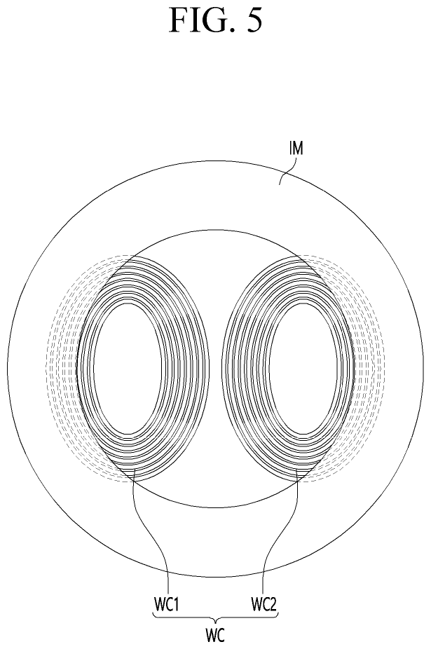

FIG. 1 is a perspective view illustrating a cooking appliance according to an embodiment of the present disclosure, FIG. 2 is a circuit diagram of a cooking appliance according to an embodiment of the present disclosure, FIG. 3 is a cross-sectional view illustrating a cooking appliance and an object to be heated according to an embodiment of the present disclosure, and FIG. 4 is a cross-sectional view illustrating a cooking appliance and an object to be heated according to another embodiment of the present disclosure.

First, referring to FIG. 1, a cooking appliance 1 according to an embodiment of the present disclosure includes a case 25, a cover plate 20, a working coil (WC), and an intermediate heating body (IM).

The WC may be installed in the case 25.

For reference, in the case 25, various devices related to driving of the working coil (for example, a power supply that provides alternating current (AC) power, a rectifier that rectifies the AC power of the power supply into direct current (DC) power, an inverter that converts the DC power rectified by the rectifier into resonance current through a switching operation to provides the resonance current to the WC, a control module that controls operations of various devices within the cooking appliance 1, a relay or semi-conductor switch that turns on or off the WC, etc.) in addition the working coils (e.g., WC1 and WC2) may be installed in the case 25.

The cover plate 20 may be coupled to an upper end of the case 25 and be provided with an upper plate 15 on which an object to be heated (HO) (not shown) is disposed on a top surface thereof.

Specifically, the cover plate 20 may include the upper plate 15 for disposing an HO, such as a cooking vessel. thereon. That is, an object to be heated may be disposed on the upper plate 15.

Here, the upper plate 15 may be made of, for example, a glass material (e.g., ceramics glass).

In addition, the upper plate 15 may be provided with an input interface (not shown) that receives an input from a user to transmit the input to a control module (not shown) for an input interface. Of course, the input interface may be provided at a position other than the upper plate 15.

For reference, the input interface may be a module for inputting a desired heating intensity or driving time of the cooking appliance 1 and may be variously implemented with a physical button or a touch panel. Also, the input interface may include, for example, a power button, a lock button, a power level adjustment button (+, −), a timer adjustment button (+, −), a charging mode button, and the like. In addition, the input interface may transmit the input received from the user to the control module for the input interface (not shown), and the control module for the input interface may transmit the input to the aforementioned control module (i.e., the control module for the inverter). In addition, the aforementioned control module may control the operations of various devices (e.g., the WCs) based on the input (i.e., a user input) provided from the control module for the input interface.

Whether the WC is driven and the heating intensity (i.e., thermal power) may be visually displayed on the upper plate 15, and may be indicated by an indicator (not shown) constituted by a plurality of light emitting devices (e.g., LEDs) provided in the case 25.

The WC may be installed inside the case 25 to heat the HO.

Specifically, the WC may be driven by the aforementioned control module (not shown), and when the HO is disposed on the upper plate 15, the WC may be driven by the control module.

In addition, the WC may directly heat an HO (i.e., a magnetic body) having magnetism and may indirectly heat an object to be used (i.e., a non-magnetic body) through an IM that will be described later.

In addition, the WC may heat the HO in an induction heating manner and may be provided to overlap the IM in a longitudinal direction (i.e., a vertical direction or an upward and downward direction).

For reference, although the structure in which one WC is installed in the case 25 is illustrated in FIG. 1, the embodiment is not limited thereto. That is, one or more WCs may be installed in the case 25. The IM may be installed to correspond to the WC. The number of TMs and the number of WCs may be the same.

The IM may be installed on the upper plate 15. The IM may be applied on the upper plate 15 to heat the non-magnetic body among the HOs. The IM may be inductively heated by the WC.

The IM may be disposed on a top surface or a bottom surface of the upper plate 15. For example, as illustrated in FIG. 2, the IM may be installed on the top surface of the upper plate 15, or as illustrated in FIG. 3, the IM may be installed on the bottom surface of the upper plate 15.

The IM may be provided to overlap the WC in the longitudinal direction (i.e., the vertical direction or the upward and downward direction). Thus, the heating of the HO may be possible regardless of the arrangement positions and types of the HOs.

Also, the IM may have at least one of magnetic and non-magnetic properties (i.e., a magnetic property, a non-magnetic property, or both the magnetic and non-magnetic properties).

In addition, the IM may be made of, for example, a conductive material (e.g., aluminum), and as illustrated in the drawings, a plurality of rings having different diameters may be installed on the upper plate 15 in a repeated shape, but is not limited thereto. That is, the IM may be made of a material other than a conductive material. Also, the IM may be provided in a shape other than the shape in which the plurality of rings having different diameters are repeated.

For reference, although a single IM is illustrated in FIGS. 3 and 4, the embodiment is not limited thereto. That is, a plurality of thin films may be installed, but for convenience of description, a single IM may be installed as an example.

FIG. 2 is a circuit diagram of a cooking appliance according to an embodiment of the present disclosure.

Referring to FIG. 2, the cooking appliance may include at least some or all of a power supply 110, a rectifier 120, a DC link capacitor 130, an inverter 140, a WC, and a resonance capacitor 160.

The power supply 110 may receive external power. The power that the power supply 110 receives from the outside may be AC power.

The power supply 110 may supply AC voltage to the rectifier 120.

The rectifier 120 is an electrical device for converting AC into DC. The rectifier 120 converts the AC voltage supplied through the power supply 110 into a DC voltage. The rectifier 120 may supply the converted voltage to both DC terminals 121.

An output terminal of the rectifier 120 may be connected to both DC terminals 121. Both DC terminals 121 output through the rectifier 120 may be referred to as a DC link. The voltage measured across both DC terminals 121 is referred to as the DC link voltage.

The DC link capacitor 130 serves as a buffer between the power supply 110 and the inverter 140. Specifically, the DC link capacitor 130 is used to maintain the DC link voltage converted through the rectifier 120 and supply the DC link voltage to the inverter 140.

The inverter 140 serves to switch a voltage applied to the WC so that a high-frequency current flows through the WC. The inverter 140 may apply current to the WC. The inverter 140 may include a relay, a semiconductor switch, or the like that turns on or off the WC. For example, the inverter 140 may include a semiconductor switch, and the semiconductor switch may be an Insulated Gate Bipolar Transistor (IGBT) or a Wide Band Gab (WBG) element, but this is only exemplary and is not limited thereto. Meanwhile, the WBG element may be SiC (Silicon Carbide), GaN (Gallium Nitride), or the like. The inverter 140 causes a high-frequency current to flow through the WC by driving the semi-conductor switch, and thus a high-frequency magnetic field is formed in the WC.

The WC may include at least one WC generating a magnetic field for heating the HO. Current may or may not flow through the WC depending on whether the switching element is driven. When a current flows through the WC, a magnetic field is generated. The WC may heat the cooking appliance by generating a magnetic field as current flows.

One side of the WC is connected to the connection point of the switching element of the inverter 140, and the other side thereof is connected to the resonant capacitor 160.

The driving of the switching element is performed by a driver (not shown), and is controlled at a switching time output from the driver to apply a high-frequency voltage to the WC while the switching elements alternately operate with each other. In addition, since the on/off time of the switching element applied from the driver is controlled in a gradually compensated manner, the voltage supplied to the WC changes from a low voltage to a high voltage.

The resonance capacitor 160 may resonate with the WC.

The resonance capacitor 160 may be a component for serving as a shock absorber. The resonance capacitor 160 affects the energy loss during the turn-off time by adjusting the saturation voltage rise rate during the turn-off of the switching element.

Next, referring to FIGS. 3 and 4, the cooking appliance 1 according to an embodiment of the present disclosure may further include at least some or all of an insulating material 35, a shielding plate 45, a support member 50, and a cooling fan 55.

The insulating material 35 may be provided between the upper plate 15 and the WC.

Specifically, the insulating material 35 may be mounted under the upper plate 15, and the WC may be disposed below the insulating material 35.

The insulating material 35 may prevent heat generated while the IM or the HO by the driving of the WC from being transmitted to the WC.

That is, when the IM or the HO is heated by electromagnetic induction of the WC, the heat of the IM or the HO may be transferred to the upper plate 15, and then, the heat of the upper plate 15 may be transferred to the WC again to damage the WC.

The insulating material 35 may block the heat transferred to the WC as described above to prevent the WC from being damaged by the heat, and furthermore, prevent heating performance of the WC from being deteriorated.

For reference, although it is not an essential component, a spacer (not shown) may be installed between the WC and the insulating material 35.

Specifically, the spacer may be inserted between the WC and the insulating material 35 so that the WC and the insulating material 35 are not in directly contact with each other. Thus, the spacer may prevent the heat generated while the IM or the HO by the driving of the WC from being transmitted to the WC through the insulating material 35.

That is, since the spacer partially shares the role of the insulating material 35, a thickness of the insulating material 35 may be minimized, and thus, a gap (or an interval) between the HO and the WC may be minimized.

In addition, the spacer may be provided in plurality, and the plurality of spacers may be disposed to be spaced apart from each other between the WC and the insulating material 35. Thus, air suctioned into the case 25 by a cooling fan 55 to be described later may be guided to the WC by the spacers.

That is, the spacers may guide the air introduced into the case 25 by the cooling fan 55 so as to be properly transferred to the WC, thereby improving cooling efficiency of the WC.

The shielding plate 45 may be mounted under the WC to block magnetic fields generated downward when the WC is driven.

Specifically, the shielding plate 45 may block the magnetic fields generated downward when the WC is driven and may be supported upward by the support member 50.

The support member 50 may be installed between a bottom surface of the shielding plate 45 and the lower plate of the case 25 to support the shielding plate 45 upward.

Specifically, the support member 50 may support the shielding plate 45 upward to indirectly support the insulating material 35 and the WC upward, and thus, the insulating material 35 may be in close contact with the upper plate 15.

As a result, the gap between the WC and the HO may be constantly maintained.

For reference, the support member 50 may include, for example, an elastic body (e.g., a spring) for supporting the shielding plate 45 upward, but is not limited thereto.

In addition, since the support member 50 is not an essential component, it may be omitted from the cooking appliance 1.

The cooling fan 55 may be installed inside the case 25 to cool the WC.

Specifically, the cooling fan 55 may be controlled to be driven by the above-described control module and may be installed on a sidewall of the case 25. The cooling fan 55 may be installed at a position other than the sidewall of the case 25, but in the present disclosure, for convenience of explanation, the structure in which the cooling fan 55 is installed on the sidewall of the case 25 will be described as an example.

In addition, as illustrated in FIGS. 3 and 4, the cooling fan 55 may suck up air from the outside of the case 25 to deliver the air to the WC or may suck up air (particularly, heated air) inside the case 25 to discharge the air outside of the case 25.

As a result, efficient cooling of the components (in particular, the WC) inside the case 25 is possible.

Also, as described above, the air outside the case 25 delivered to the WC by the cooling fan 55 may be guided to the WC by the spacers. Thus, the direct and efficient cooling of the WC is possible to improve durability of the WC (i.e., improvement in durability due to prevention of thermal damage).

The IM may be a material having a resistance value that is capable of being heated by the WC.

A thickness of the IM may be inversely proportional to the resistance value (i.e., a surface resistance value) of the IM. That is, as the thickness of the IM decreases, the resistance value (i.e., surface resistance value) of the IM increases. Thus, characteristics of the IM may be changed to a load that may be heated.

For reference, the IM according to the embodiment of FIG. 2 through FIG. 3 may have a thickness of, for example, about 0.1 μm to about 1,000 μm, but is not limited thereto.

The IM having such characteristics may be present to heat the non-magnetic body, and thus, impedance characteristics between the IM and the HO may be changed according to whether the HO disposed on the upper plate 15 is a magnetic body or non-magnetic body.

The case in which the HO is the magnetic body will be described as follows.

When the magnetic HO is disposed on the upper plate 15, and the working coil WC is driven, a resistance component (R1) and an inductor component (L1) of the HO, which has the magnetism as illustrated in FIG. 4 may form an equivalent circuit with a resistance component (R2) and an inductor component (L2) of the IM. In this case, the impedance (i.e., impedance measured by R1 and L1) of the HO, which has the magnetism, in the equivalent circuit may be less than that of the IM (i.e., the impedance measured by R2 and L2). Thus, when the equivalent circuit as described above is formed, magnitude of the eddy current I1 applied to the magnetic HO may be greater than that of the eddy current I2 applied to the IM. Thus, most of the eddy current generated by the WC may be applied to the HO, and thus, the HO may be heated. That is, when the HO is the magnetic body, the above-described equivalent circuit may be formed, and thus, most of the eddy current may be applied to the HO. As a result, the WC may directly heat the HO.

Next, the case in which the HO is the non-magnetic body will be described as follows.

When the HO, which does not have the magnetism, is disposed on the upper plate 15, and the WC is driven, there is no impedance in the non-magnetic HO, and the IM may have an impedance. That is, the resistance component R and the inductor component L may exist only in the IM. Therefore, when the non-magnetic HO is disposed on the upper plate 15 and the WC is driven, as illustrated in FIG. 4, the resistance component R and the inductor component L of the IM may form an equivalent circuit. Thus, eddy current I may be applied only to the IM, and eddy current may not be applied to the HO, which does not have magnetism. More specifically, the eddy current I generated by the WC may be applied only to the IM, and thus, the IM may be heated. That is, when the HO is the non-magnetic body, as described above, the eddy current I may be applied to the IM to heat the IM, and the HO, which does not have magnetism, may be indirectly heated by the IM heated by the WC. In this case, the IM may be a main heating source.

In summary, the HO may be directly or indirectly heated by a single heat source, which is called the WC, regardless of whether the HO is the magnetic body or the non-magnetic body. That is, when the HO is the magnetic body, the WC may directly heat the HO, and when the HO is the non-magnetic body, the IM heated by the WC may indirectly heat the HO.

Meanwhile, when the HO is a magnetic material, the heating efficiency is highest when all of the magnetic field generated from the WC is combined with the HO, but as a portion of the magnetic field is combined with the IM, there might be a problem in that the heating efficiency is somewhat lowered. Therefore, when the HO is a magnetic material, the coupling force between the magnetic field generated from the WC and the IM is adjusted weakly, and when the HO is a non-magnetic material, there is a need for a method that can strongly control the coupling force between the magnetic field generated from the WC and the IM.

Accordingly, the cooking appliance 1 according to the embodiment of the present disclosure includes a plurality of WCs, and by selectively driving the plurality of WCs, controls the coupling force between the magnetic field generated from the WCs and the IM. In other words, the cooking appliance 1 includes a plurality of WCs, and by selectively driving the plurality of WCs, the heating value of the IM is adjusted.

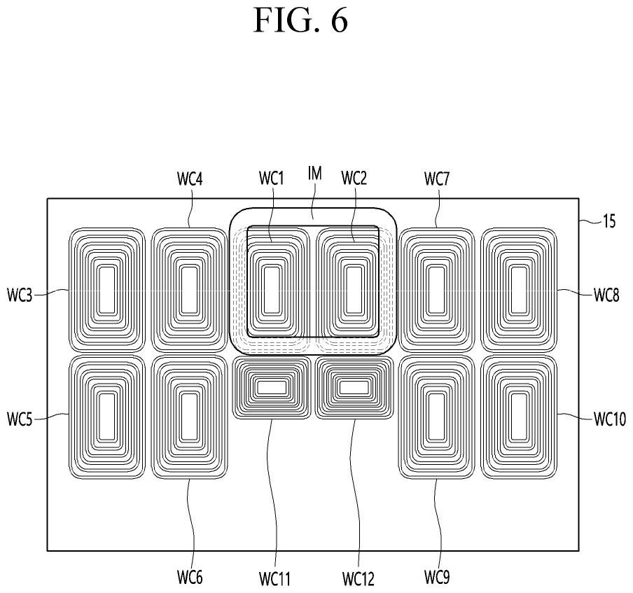

To this end, the IM may be disposed to overlap at least two or more WCs of the plurality of WCs in the vertical direction, and various embodiments according to this will be described with reference to FIGS. 5 to 8.

FIG. 5 is a view illustrating the IM and a plurality of WCs according to a first embodiment of the present disclosure.

The cooking appliance 1 may include two working coils (WC1 and WC2). In other words, the plurality of WCs may include the WC1 and WC2.

At least a portion of each of the WC1 and WC2 may be disposed to overlap the IM in a vertical direction. Referring to the example of FIG. 5, the IM may have a circular shape with a hole in the center. However, this is merely exemplary, and the IM may have a rectangular or elliptical shape with a hole in the center.

Each of the WC1 and WC2 may also be wound in a shape such as a circle or an ellipse with a hole in the center. However, this is also just an example, and each of the WC1 and WC2 may have a rectangular shape with a hole in the center. The WC1 and WC2 may be disposed side by side.

Each of the WC1 and WC2 may partially overlap the IM in the vertical direction and may not overlap the IM in the vertical direction. For example, at least a portion of each of the WC1 and WC2 may be positioned below a hole formed in the IM.

FIG. 5 is a view from above of a plurality of working coils (e.g., WC1 and WC2) and the IM disposed thereon, a portion that overlaps the IM among the WC1 and WC2 in the vertical direction is illustrated as a dotted line, and a portion that does not overlap the IM in the vertical direction is illustrated as a solid line.

In other words, all of the plurality of working coils (i.e., WC1 and WC2) may include at least a portion overlapping with the IM in the vertical direction.

By having a small number of WCs, cost is reduced and the structure is simplified.

FIG. 6 is a view illustrating the IM and a plurality of WCs according to a second embodiment of the present disclosure.

The cooking appliance 1 includes a plurality of WCs, and the IM may be disposed to vertically overlap some of the plurality of WCs.

Referring to the example of FIG. 6, the IM may have a rectangular shape with a hole in the center. However, this is merely exemplary, and the IM may have a shape such as a circle or an ellipse with a hole in the center.

Each of the plurality of WCs may also be wound in a rectangular shape with a hole in the center. However, this is also just an example, and each of the WCs may alternatively be wound in a circular or elliptical shape with a hole in the center.

According to the example of FIG. 6, the plurality of WCs may include first to twelfth working coils WC1 to WC12.

Each of WCs may have different sizes. For example, as illustrated in FIG. 6, the first to tenth working coils WC1 to WC10 have a first size, and the eleventh to twelfth working coils WC11 and WC12 may have a second size which is smaller than the first size. However, this is merely exemplary, and the size of each of the WC1 to WC12 may vary.

The IM may be disposed to overlap some of the WCs in a vertical direction. When a plurality of heating zones is designated in advance in the upper plate 15, the IM may be installed in a position corresponding to at least one of the plurality of heating zones. The heating zone may mean a region in which the HO can be heated.

For example, in the example of FIG. 6, the first to fourth heating zones may be previously designated in the upper plate 15. For example, the first heating zone is a region in which the HO can be heated by the WC1 and WC2, and the second heating zone is a region in which the HO can be heated by the WC3 to WC6, the third heating zone is a region in which the HO can be heated by the WC7 to WC10, and the fourth heating zone may be a region in which the HO can be heated by the WC11 and WC12.

According to the example of FIG. 6, the IM may be installed at a position corresponding to the first heating zone. In other words, the IM may be disposed to overlap the WC1 and WC2 in the vertical direction among the plurality of WCs and may be disposed at a position that does not overlap in the vertical direction with the other WCs.

In addition, each of the WC1 and WC2 may be disposed such that a portion thereof overlaps the IM in the vertical direction and the rest overlaps the hole formed in the IM in the vertical direction. FIG. 6 is a view from above of a plurality of WCs (e.g., WC1 to WC12) and the IM disposed thereon, a portion that overlaps the IM among the WC1 and WC2 in the vertical direction is illustrated as a dotted line, and a portion that does not overlap the IM in the vertical direction is illustrated as a solid line.

In other words, according to the second embodiment, a portion of the plurality of WCs (e.g., WC1 to WC12), for example, a WC corresponding to the first heating zone may include a portion overlapping with the IM in the vertical direction.

A magnetic container-only heating zone (second to fourth heating zones) capable of heating only a magnetic container and a combined heating zone (first heating zone) capable of heating both magnetic and non-magnetic containers are all implemented on the cooking appliance 1, and there is an advantage of maximizing heating efficiency in each heating zone.

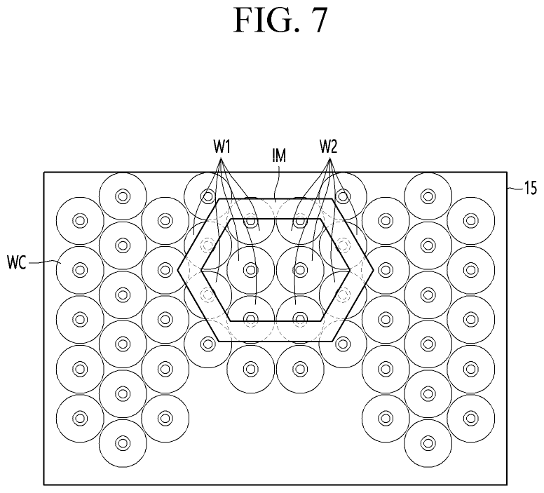

FIG. 7 is a diagram illustrating an IM and a plurality of WCs according to a third embodiment of the present disclosure.

The cooking appliance 1 includes a plurality of WCs, and the IM may be disposed to overlap some of the plurality of WCs in the vertical direction.

Referring to the example of FIG. 7, the IM may have a hexagonal shape with a hole in the center. However, this is merely exemplary, and the IM may have a shape such as a circle, an ellipse, or a rectangular with a hole in the center.

Each of the plurality of WCs may also be wound in a circular shape with a hole in the center. However, this is also just an example, and each of the plurality of WCs may be wound in a circular, elliptical, or rectangular shape with a hole in the center.

According to the example of FIG. 7, the plurality of WCs may include forty-eight small WCs. However, since the number of WCs is merely exemplary, it is reasonable not to be limited thereto.

Each of the plurality of WCs may have the same size. Unlike the example of FIG. 7, the size of each of the plurality of WCs may be different.

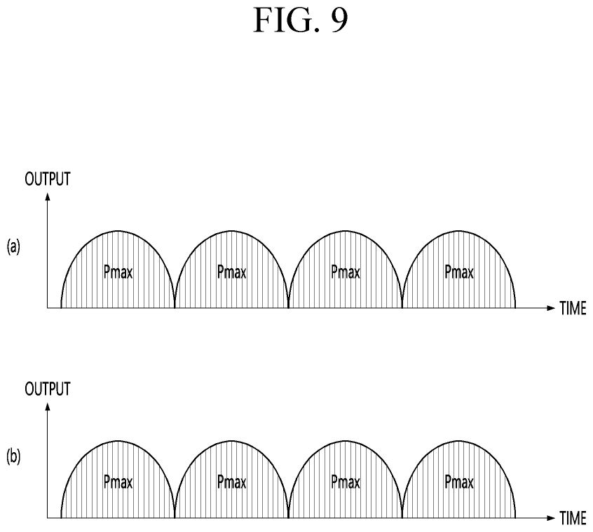

Of the plurality of WCs illustrated in FIG. 7, WCs overlapping in the vertical direction or adjacent to the left half of the IM are divided as first working coils (WC1), and WCs overlapping in the vertical direction or adjacent to the right half of the IM may be divided as second working coils (WC2). This is divided to explain the operating method of the WC when the HO is located at a position corresponding to the IM, which will be described in FIGS. 9 to 11.

As in the example of FIG. 7, when a plurality of small WCs having a predetermined size or less are disposed, the heating zone may not be designated in advance in the upper plate 15. In this way, the cooking appliance 1 to which the heating zone is not designated detects the position where the HO is disposed on the upper plate 15, and a WC disposed at a position overlapping the position of the sensed HO in the vertical direction may operate.

The IM may be disposed to overlap some of the plurality of WCs in a vertical direction. As in the example of FIG. 7, the IM may be installed at a position corresponding to the center of the plurality of WCs. However, this is merely exemplary, and at least a portion of the IM may be installed at a position overlapping the WC disposed closest to the edge of the upper plate 15 in the vertical direction. In other words, in the cooking appliance 1 where no heating zone is designated, the IM may be installed in various positions. The IM is installed at a position where the HO is frequently placed to increase user convenience for users who frequently use a non-magnetic container, or is installed at a position where the HO is not well placed to increase user convenience for users who frequently use a magnetic container.

The HO can be heated at any position regardless of the position or size thereof, so there is an advantage in that the degree of freedom of the container is improved.

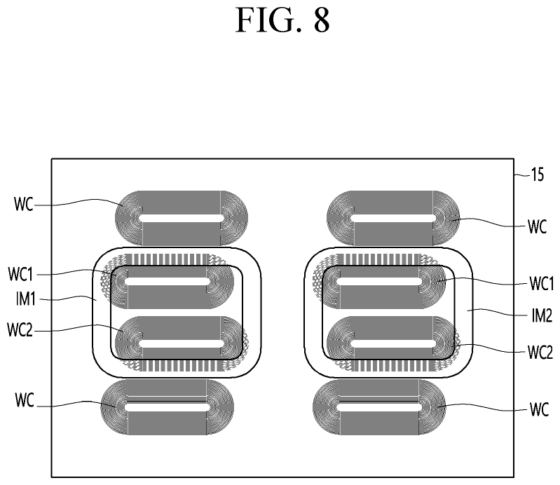

FIG. 8 is a diagram illustrating an IM and a plurality of WCs according to a fourth embodiment of the present disclosure.

The cooking appliance 1 may include a plurality of WCs and a plurality of IMs overlapping some of the plurality of WCs in the vertical direction.

Referring to the example of FIG. 8, the IM may have a rectangular shape with a hole in the middle, but this is merely an example, and may have various shapes such as a circle, an ellipse, or a hexagon.

Each of the plurality of WCs may have an elliptical shape with a hole in the center, but this is merely an example, and may have various shapes such as a circle, a rectangular, or a hexagon.

According to the example of FIG. 8, the plurality of WCs may include four WCs located on the left side and four WCs located on the right side. In this case, the heating zone may include a first heating zone heated by four WCs disposed on the left side and a second heating zone heated by four WCs disposed on the right side.

Meanwhile, the IM may include a first intermediate heating body (IM1) disposed at a position corresponding to the first heating zone and a second intermediate heating body (IM2) disposed at a position corresponding to the second heating zone.

Meanwhile, of the plurality of WCs illustrated in FIG. 8, a WC adjacent to an upper portion of each of the IM1 and IM2 may be divided as the WC1, and a WC adjacent to the lower portion of that may be divided as the WC2. This is merely a division to explain the operating method of the WC when the HO is located at a position corresponding to the IM, which will be described in FIGS. 9 to 11.

There is an advantage in that both magnetic and non-magnetic containers can be heated in all heating zones.

As described above, according to various embodiments of the present disclosure, the cooking appliance 1 includes a plurality of WCs and at least one IM, and the IM may be disposed to overlap two or more WCs of the plurality of the WCs in a vertical direction. In addition, the cooking appliance 1 can improve the heating efficiency of the magnetic container by controlling the heating value of the IM by alternately operating the plurality of WCs.

Specifically, when the HO is placed at a position overlapping the IM in the vertical direction, the WCs located adjacent to the IM are divided into the first working coil and the second working coil to be capable of operating alternately. In this case, when dividing the IM into halves (left/right or upper/lower), the WC1 and WC2 may include WCs corresponding to the divided regions, respectively.

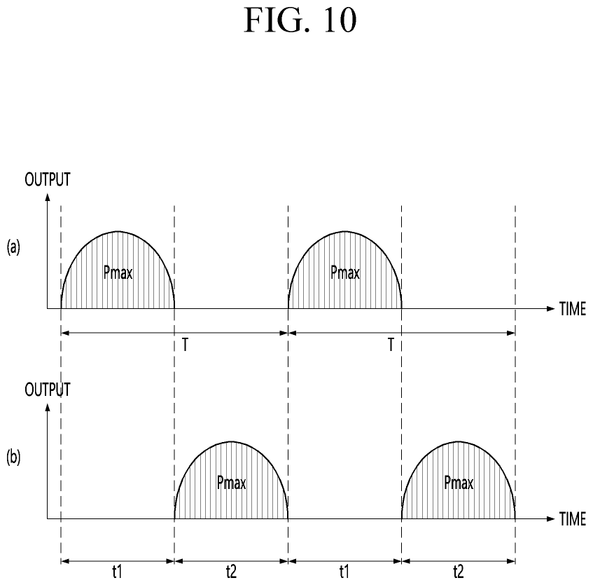

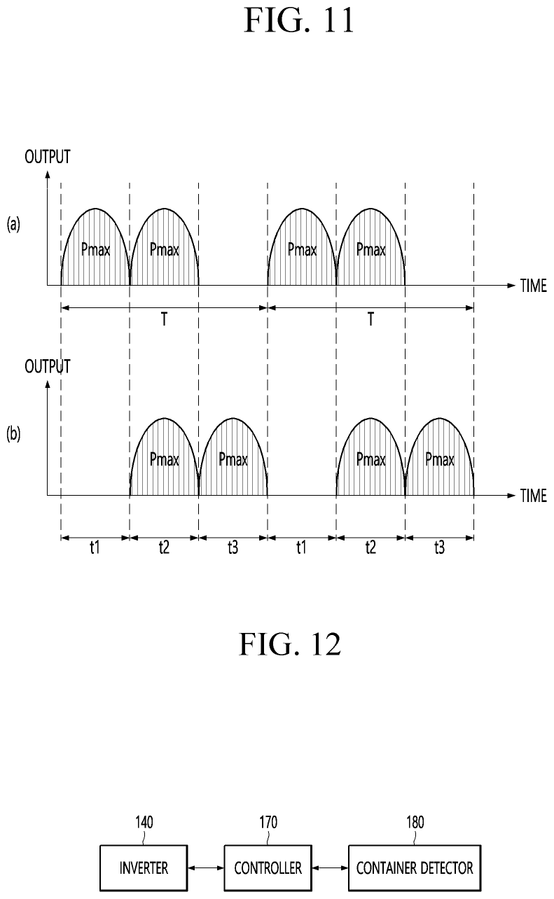

FIG. 9 is a view illustrating output when WCs of a cooking appliance 1 operate simultaneously according to an embodiment of the present disclosure, FIG. 10 is a view illustrating output when WCs of a cooking appliance 1 alternately operate in a first method according to an embodiment of the present disclosure, and FIG. 11 is a view illustrating an output when a WC of a cooking appliance 1 alternately operates in a second method according to an embodiment of the present disclosure.

FIGS. 9 to 11 illustrates the output of the WC1 and the output of the WC2 when the IM and the plurality of WCs are disposed according to the first embodiment described in FIG. 5. In other words, in FIGS. 9 to 11, (a) represents the output of the WC1, and (b) represents the output of the WC2.

However, this has been described only for the first embodiment for convenience of description, and similar outputs may be obtained in the second to fourth embodiments. In other words, when the IM and the plurality of WCs are disposed according to the second to fourth embodiments described through each of FIGS. 6 to 8, (a) of FIGS. 9 to 11 may represent the WC1, and (b) may represent the output of the WC2.

In addition, in FIGS. 9 to 11, the outputs of the WC1 and WC2 may be maximum outputs of the WC1 and WC2, respectively. In other words, in FIGS. 9 to 11, when the input voltage of the inverter 140 is constant and the WC is driven at an operating frequency at which a current outputting maximum power is applied, it can be the output of the WC1 and WC2, respectively.

First, referring to FIG. 9, the WC1 and WC2 may continuously operate concurrently for one cycle, and in this case, the WC1 and WC2 can continuously output maximum power (Pmax) for one cycle, respectively. When the WC1 and WC2 operate simultaneously, a closed loop may be formed in the entire region of the IM, that is, since the closed loop is formed to the maximum size and thus the magnetic field coupling force of the IM is high, the heating value may be maximum.

Therefore, since the heating efficiency of the HO having magnetic properties may be lowered, according to various embodiments of the present disclosure, the WC1 and WC2 alternately operate to weakly adjust the magnetic field coupling force of the IM. In other words, according to various embodiments of the present disclosure, one IM can operate alternately a first working coil (WC1) adjacent to the left (or upper side) and a second working coil (WC2) adjacent to the right (or lower side).

First, referring to FIG. 10, the WC1 and WC2 may not operate during at least a portion (or interval) of one cycle (or a single cycle). Specifically, when one cycle is divided into a first section (t1) and a second section (t2), the WC1 operates only in the t1 and does not operate in t2, and the WC2 may operate only in the t2 and may not operate in t1.

Accordingly, in t1, the closed loop is formed only in the left (or upper) region of the IM, and accordingly, the magnetic field coupling force may be reduced than when the closed loop is formed in the entire region of the IM. Similarly, in t2, the closed loop is formed only in the right (or lower) region of the IM, and accordingly, the magnetic field coupling force may be reduced than when the closed loop is formed in the entire region of the IM.

Next, referring to FIG. 11, the WC1 and the WC2 may not operate during at least a portion of one cycle. Specifically, when one cycle is divided into a first section (t1), a second section (t2), and a third section (t3), the WC1 operates only t1 and t2 and does not operate in t3, and the WC2 operates only in t2 and t3 and may not operate in t1.

Accordingly, in t1, the closed loop is formed only in the left (or upper) region of the IM, and accordingly, the magnetic field coupling force may be reduced than when the closed loop is formed in the entire region of the IM. In t2, a closed loop is formed over the entire region of the IM, so that the magnetic field coupling force of the IM can be stronger than in t1 and t3. Again, in t3, the closed loop is formed only in the right (or lower) region of the IM, and accordingly, the magnetic field coupling force may be weaker than when the closed loop is formed in the entire region of the IM.

Meanwhile, the operation cycle of the inverter 140 is described as being divided into two sections in FIG. 10 and as being divided into three sections in FIG. 11, but this is merely exemplary, and the operation cycle may be divided into two or more sections.

In other words, the operation cycle of the inverter 140 is divided into two or more sections, and at least one of the plurality of WCs may not operate in at least one section. As such, when at least one of the plurality of WCs does not operate in at least one section, the area of the closed loop formed in the IM is narrowed, and accordingly, as the magnetic field coupling force of the IM is weakened, the heating efficiency may be improved by increasing the magnetic field coupled to the HO.

Meanwhile, when heating the HO having magnetic properties, as described above, at least one of the plurality of WCs does not operate in at least a portion of the section, so that the heating efficiency can be improved, but in a case of heating the non-magnetic HO, heating efficiency can be maximized only when all WCs operate.

Accordingly, the cooking appliance 1 may operate in different heating modes according to the type of the HO. Next, referring to FIG. 12, a method of operating the cooking appliance 1 in different heating modes according to the HO will be described.

FIG. 12 is a control block diagram illustrating an operating method of a cooking appliance 1 according to an embodiment of the present disclosure.

The cooking appliance 1 may include an inverter 140, a controller 170 and a container detector 180. FIG. 12 illustrates only some components for explaining the operation method of the cooking appliance 1, and the cooking appliance 1 may further include components other than the components illustrated in FIG. 12.

The inverter 140 may be driven so that current is supplied to the WC.

The controller 170 may control the operation of the cooking appliance 1. The controller 170 may control each of the inverter 140 and the container detector 180.

The container detector 180 may detect the HO. The container detector 180 may detect the type or size of the HO. The type of the HO may include the material of the HO. The type of the HO may be magnetic or non-magnetic (including non-metal).

The container detector 180 may include at least one sensor (not shown) for detecting the type or size of the container.

The container detector 180 may detect the type or size of the HO by receiving a user input for selecting at least one of the type or size of the HO. In this case, the container detector 180 may include an input interface (not shown) for receiving a user input.

The container detection portion 180 may detect the type or size of the HO according to a pre-stored container detection algorithm. For example, the container detector 180 may detect the type or size of the HO based on at least one data such as the magnitude of current flowing through the WC for a predetermined time after starting the heating mode and the magnitude of the output.

In other words, there are various methods for detecting the HO by the container detector 180 is varies, and the present disclosure is not limited thereto.

The controller 170 may operate in the first heating mode or the second heating mode according to the type of the HO. The first heating mode may be an operational mode for heating the magnetic container, and the second heating mode may be an operational mode for heating the non-magnetic container.

The controller 170 may control the inverter 140 to operate in the first heating mode when the HO is a magnetic material and to operate in the second heating mode when the HO is a non-magnetic material.

When operating in the first heating mode, the controller 170 may control the inverter 140 so that at least one of the plurality of WCs does not operate in at least a partial section of one cycle, and when operating in the second heating mode, during one cycle, may control the inverter 140 so that all WCs operate.

According to the first embodiment, when operating in the first heating mode, the controller 170 may alternately operate the WC in the first method described in FIG. 10. Specifically, the controller 170 may control the inverter 140 so that only the WC1 operates for half of one cycle and only the WC2 operates for the other half thereof.

According to the second embodiment, when operating in the first heating mode, the controller 170 may alternately operate the WC in the second method described in FIG. 11. Specifically, the operation cycle of the inverter 140 may include a section in which only the WC1 operates, a section in which only the WC2 operates, and a section in which only the WC1 and the WC2 operate together. The controller 170 may control the inverter 140 so that only the WC1 operates together during t1 of one cycle, and the WC1 and the WC2 operates during t2 after t1, and only the WC2 operates during t3 after t2. Meanwhile, the order of t1 to t3 may be changed. In other words, when t1 is a section in which only the WC1 operates, t2 is a section in which the WC1 and WC2 operate together, and t3 is a section in which only the WC2 operates, such as an operation in the order of t1, t3, and t2, and an operation in the order of t2, t3, and t1, the order of operation can be changed.

A time interval corresponding to each of t1 to t3 may be the same. In other words, each section divided in one cycle may be equal.

The controller 170 may adjust the operating frequency of the inverter 140 so that each of the plurality of WCs produces a maximum output (Pmax) when operated in each of the first heating mode and the second heating mode. The Pmax may mean the maximum power that one WC can output. When one coil operates at Pmax, it may have a cycle of 120 Hz component twice that of commercial power.

Hereinafter, when the plurality of WCs and the IM are configured as illustrated in FIG. 5, the output of the WC will be described.

In the first heating mode, each WC operates to generate maximum output Pmax, and during one cycle, the output may be greater than or equal to the Pmax. In the case of the first embodiment, since the output is the Pmax in t1, and the output is the Pmax in t2, the output per coil during one cycle T is ½*maximum power (½*Pmax), and the total power may be the Pmax. In the case of the second embodiment, since the output is the Pmax in t1, the output is 2*maximum output (2*Pmax) in t2, and the output in t3 is the Pmax, the output per coil during one cycle T may be ⅔ *maximum output (⅔*Pmax), and the total output may be 4/3*maximum output (4/3*Pmax).

In other words, although there is a section in which all WCs do not simultaneously operate in the first heating mode, the Pmax can be guaranteed.

Meanwhile, since, in the second heating mode, all WCs are operated to produce maximum output, during one cycle T, the output per coil may be the Pmax, and the total output may be 2*maximum output (2*Pmax).

According to various embodiments of the present disclosure, there is an advantage in that the cooking appliance 1 can not only heat all of the HOs regardless of the material, but also heating efficiency for each material can be improved and output performance can be increased, by suppressing the heating value of the IM when heating the magnetic material through configuration and control of a plurality of WCs and maximizing the heating value generated by the IM when heating the non-magnetic material. In addition, since the plurality of WCs is alternately controlled and the WCs operate in the same phase, there is no need for separate phase control, so the control logic can be simplified.

The above description is merely an example of the technical idea of the present disclosure, and various modifications and variations may be made to those skilled in the art without departing from the essential characteristics of the present disclosure.

Therefore, the embodiments disclosed in this disclosure are not intended to limit the technical spirit of the present disclosure, but to explain, and the scope of the technical spirit of the present disclosure is not limited by these embodiments.

The protection scope of the present disclosure should be construed by the claims below, and all technical ideas within the scope equivalent thereto should be construed as being included in the scope of the present disclosure.

What is claimed is:

1. A cooking appliance comprising:
an upper plate configured to support an object to be heated;
a first intermediate heating body located at the upper plate;
a plurality of working coils configured to generate magnetic fields, the magnetic fields being coupled to at least one of the object to be heated and the first intermediate heating body;
an inverter configured to apply current to the plurality of working coils; and
a controller configured to control the inverter so that at least one of the plurality of working coils does not operate in a portion of a cycle in a first heating mode.

2. The cooking appliance of claim 1, wherein the plurality of working coils includes:
a first working coil; and
a second working coil, and
wherein the controller is configured to control the inverter so that:
the first working coil is operated for a first half of the cycle; and
the second working coil is operated for a second half of the cycle.

3. The cooking appliance of claim 1, wherein the plurality of working coils includes:
a first working coil; and
a second working coil,
wherein the cycle is divided into a first section, a second section, and a third section, and
wherein the controller is configured to control the inverter so that:
only the first working coil is operated during the first section;
the first working coil and the second working coil are operated together during the second section; and
only the second working coil is operated during the third section.

4. The cooking appliance of claim 3, wherein the controller is configured to control the inverter so that first section, the second section, and the third section are sequentially performed.

5. The cooking appliance of claim 4, wherein a time interval for each of the first section, the second section, and the third sections is the same.

6. The cooking appliance of claim 1, wherein the controller is configured to adjust an operating frequency of the inverter so that the plurality of working coils generates maximum output in the first heating mode.

7. The cooking appliance of claim 1, wherein the controller is configured to control the plurality of working coils to operate in the first heating mode when the object to be heated is a magnetic material.

8. The cooking appliance of claim 1, wherein the controller is configured to control the inverter so that all working coils operate during a cycle in a second heating mode.

9. The cooking appliance of claim 8, wherein the controller is configured to control the plurality of working coils to operate in the second heating mode when the object to be heated is a non-magnetic material.

10. The cooking appliance of claim 1, wherein the first intermediate heating body overlaps in a vertical direction with at least two working coils among the plurality of working coils.

11. The cooking appliance of claim 10, wherein the plurality of working coils are arranged into a plurality of heating zones, and
wherein the first intermediate heating body is located at a position corresponding to one of the plurality of heating zones.

12. The cooking appliance of claim 10, wherein the first intermediate heating body is located at a position corresponding to a center of the plurality of working coils.

13. The cooking appliance of claim 10, wherein a portion of the first intermediate heating body is located at a position overlapping with a working coil among the plurality working coils located closest to an edge of the upper plate.

14. The cooking appliance of claim 1, wherein the first intermediate heating body is located on an upper surface of the upper plate or a lower surface of the upper plate.

15. The cooking appliance of claim 1, further comprising a second intermediate heating body located at the upper plate,
wherein the first intermediate heating body overlaps in a vertical direction with at least two working coils among the plurality of working coils, and
wherein the second intermediate heating body overlaps in a vertical direction with at least another two working coils among the plurality of working coils.

16. A cooking appliance comprising:
an upper plate configured to support an object to be heated;
a first intermediate heating body located at the upper plate;
a plurality of working coils configured to generate magnetic fields, the magnetic fields being coupled to at least one of the object to be heated and the first intermediate heating body;
an inverter configured to apply current to the plurality of working coils; and
a controller configured to control the inverter so that:
at least one of the plurality of working coils does not operate in a portion of a cycle in a first heating mode when the object to be heated is a magnetic material; and
all of the plurality of working coils operate during a cycle in a second heating mode when the object to be heated is a non-magnetic material.

17. The cooking appliance of claim 16, wherein the plurality of working coils includes:
a first working coil; and
a second working coil, and
wherein the controller is configured to control the inverter so that:
the first working coil is operated for a first half of the cycle; and
the second working coil is operated for a second half of the cycle.

18. The cooking appliance of claim 16, wherein the plurality of working coils includes:
a first working coil; and
a second working coil,
wherein the cycle is divided into a first section, a second section, and a third section, and
wherein the controller is configured to control the inverter so that:
only the first working coil is operated during the first section;
the first working coil and the second working coil are operated together during the second section; and
only the second working coil is operated during the third section.

19. The cooking appliance of claim 18, wherein the first intermediate heating body is located on an upper surface of the upper plate or a lower surface of the upper plate.
